(19) United States
(12) Patent Application Publication
(10) Pub. No.: US 2026/0264918 A1
(43) Pub. Date: Sep. 10, 2026

(54) LABELING MODULE WITH OPTIMIZED START-UP

(71) Applicant: SIDEL PARTICIPATIONS, OCTEVILLE-SUR-MER (FR)

(72) Inventors: Mattia GIULIANI, Mantova (IT); Alberto RIZZI, Mantova (IT)

(21) Appl. No.: 18/875,539

(22) PCT Filed: Oct. 11, 2022
(86) PCT No.: PCT/IB2022/059726

§ 371 Date: Dec. 16, 2024

(51) Int. Cl. B65C 9/42; B65C 9/18

(52) U.S. Cl. CPC B65C 9/42; B65C 9/1869

(57) ABSTRACT

Described is a labeling module for a labeling machine configured to label containers designed to contain a pourable product by means of labels obtained from a strip of labeling material. Also described is a packaging line for packaging a pourable product, the packaging line including the labeling machine. Also described are methods for labeling containers for a pourable product using the labeling machine.

### TECHNICAL SECTOR

The present invention relates to a labeling module for a labeling machine configured to label containers designed to contain a pourable product, preferably of the alimentary type, in particular a labeling machine for applying onto the aforementioned containers labels obtained from a strip of labeling material.

The present invention also relates to a method of labeling containers designed to contain a pourable product, preferably of the alimentary type.

### PRIOR ART

Labeling machines widely used to prepare, transport and apply labels onto containers, in particular bottles, flacons, small jars or the like, made of plastic or glass, suitable for containing, or intended to contain or be filled with, a pourable product, preferably of the alimentary type, are known.

Particularly widespread is the use of glued labels, which are obtained from a strip of labeling material initially wound in the form of a continuous strip onto one or more reels.

In detail, said strip is cut into same-size portions to which glue is applied. The glue is then applied by means of gluing means, for example a gluing roller, spray systems, injection systems, or the like. The labels thus obtained are then transferred and applied onto the outer side surface of the respective containers.

Another type of labeling operation which is particularly common involves the formation of tubular labels, or “sleeve labels”, which are made from a strip of heat-shrinkable film initially wound in the form of a continuous strip onto one or more reels; these sleeve labels are applied with a certain amount of play onto the respective containers and then heated in an oven in order to make them shrink and adhere perfectly onto the side surfaces of the said containers. This type of label does not involve the use of glue.

Irrespective as to the type of label used, a labeling machine comprises typically:
a carousel rotating about a central axis which is usually vertical and configured to convey a series of containers along a horizontal labeling path in the form of a circle arc;
an inlet station, in which the containers to be labeled are fed to the carousel;
an output station, in which the labeled containers exit the carousel; and
one or more labeling modules arranged along the periphery of the carousel and configured to feed respective pluralities of labels to the said carousel at an application station so that these labels can be applied onto the respective containers.

Generally speaking, the labeling module comprises:
a feeding system for unwinding the strip from the respective reel of labeling material, which is typically supported by a corresponding shaft rotatably mounted on the labeling module, and for advancing or feeding or supplying the strip along a feed path;
a plurality of support rollers for supporting and guiding the strip unwound from the reel along the feed path;
a cutting device arranged downstream of the feeding system, along the feed path, and configured to cut repeatedly the strip so as to obtain therefrom a series of single portions of labeling material defining the labels; and
a label transfer device, configured to receive, retain and advance each label previously separated from the strip and to feed this label to the carousel at the application station.

In the case of sleeve labels, the labels are wound in tubular form around respective forming spindles made to advance by the carousel and carrying at the top the containers to be labeled; the labels are then welded together at their superimposed ends; at this point the spindles are retracted inside the base of the carousel so as to allow the insertion with play of the containers inside the respective sleeve labels; then the containers with the “loose” labels are conveyed to the heating oven so as to obtain heat-shrinking of the labels and perfect adhesion of these labels onto the said containers.

Typically, the transfer device is defined by a vacuum drum rotatable about a fixed central axis and configured to receive the previously cut labels on an outer side surface thereof, so as to retain them by means of suction and, after rotation through a given angle about its central axis, to release these labels to the application station, So that they are applied onto the respective containers or onto the forming spindles.

More precisely, the vacuum drum comprises, on its outer side surface, a plurality of receiving sectors which are configured to receive and retain one label at a time and each comprising a respective pair of so-called pads, i.e. a front pad and a rear pad, which grip and retain, during use, the longitudinal ends of each label.

In the case of labels where glue is used, the labeling module also comprises at least one gluing roller arranged substantially at a tangent to the vacuum drum so as to spread glue over at least the longitudinal ends of each single label.

Typically, the feeding system comprises a feed roller rotatable about a first axis and able to be rotationally operated so as to cause the advancing movement of the strip by means of gripping on an outer side surface thereof.

Generally, the cutting device is of the rotary type and comprises a first roller (or “blade roller”) carrying a cutting member (for example a knife or a blade), and a second roller (or “counter-blade roller”) carrying and/or defining a counter-blade element, for example a recess designed to be cyclically engaged by the cutting member or a bearing surface for the cutting member.

The first roller and the second roller are arranged adjacent to each other and are rotatable about respective axes, which are typically parallel to each other, so as to convey cyclically the cutting member and the counter-blade element to a cutting station where they cooperate in order to cut the strip and obtain a label.

The labeling machines of the type described above typically form part of line for packaging a pourable product including further units or machines, for example a blowing machine and a filling machine.

During operation, namely during the normal productive packaging process, the rotation of the carousel is synchronized with the respective conveyors (generally carousels) of the further machines, depending on the production rate.

Therefore, the packaging machine must operate a working speed which is dependent on the production rate.

It is known in the sector that labeling machines, and in particular the labeling module, has a start-up transient, during which the vacuum drum, the cutting rollers and the feed rollers are switched from a non-operative stop condition to an operative working condition, by means of a transient start-up condition.

According to the prior art, the vacuum drum, the cutting rollers and the feed roller are started together, namely they are accelerated simultaneously and with the same acceleration ramp, from respective initial linear peripheral speeds, which are for example zero, to linear peripheral working speeds (which are generally different from each other).

Obviously, this results in the supplying, during the start-up transient, of a certain quantity of strip material towards the vacuum drum and, therefore, through the cutting station. Therefore, during the start-up transient, a certain number of labels are actually produced by means of interaction of the strip with the cutting rollers, which labels, however, must be discarded for as long as the linear peripheral speed of the vacuum drum does not correspond to the linear peripheral speed of the containers conveyed by the carousel, at the application station.

This therefore results in the discarding of a relatively large number of labels and therefore wastage of labeling material, said number increasing with the increase in the production rate, namely the increase in the speed of rotation of the carousel, since the duration of the start-up transient increases.

Some known solutions involve sudden accelerations of the feed roller in order to achieve a shorter start-up transient.

However, a sudden acceleration of the feed roller results in high stresses on the strip in the longitudinal direction, which may result in excessive stretching of the strip.

In order to overcome this, some known configurations envisage the use of complicated and costly compensation systems upstream of the feeding system, such as buffers or mechanisms for temporarily disengaging the feed roller and the strip. Moreover, more powerful motors and transmissions are needed, with a further increase in dimensions and costs.

### SUBJECT-MATTER AND SUMMARY OF THE INVENTION

The object of the present invention is to provide a labeling module, together with an associated method, which offers a high degree of reliability and has a low cost and is able to overcome at least one some of the aforementioned drawbacks associated with the labeling modules of the known type.

According to the invention, this object is achieved by a labeling module, and by an associated method, as claimed in the attached independent claims.

### BRIEF DESCRIPTION OF THE DRAWINGS

For a better understanding of the present invention, a preferred non-limiting embodiment thereof is described purely by way of example and with the aid of the attached drawings, in which:

FIG. 1 is a schematic view from above, with parts omitted for greater clarity, of a labeling machine comprising a labeling module provided in accordance with the present invention;

FIGS. 2 to 4 are schematic views from above, on a larger scale and with parts omitted for greater clarity, of part of the labeling module according to FIG. 1, during three separate and successive time instants; and

FIGS. 5 and 6 show graphs illustrating the progression over time of the speed, preferably the linear peripheral speed, of some components of the labeling module during a transient start-up condition, according to two different control methods.

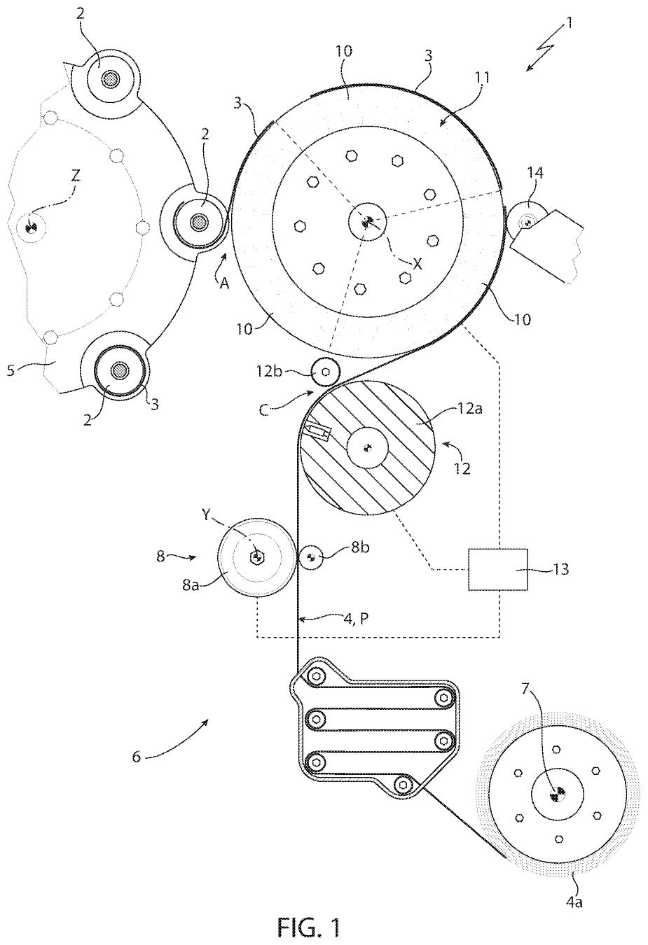

### DETAILED DESCRIPTION

With reference to the attached figures, 1 denotes overall a labeling machine for labeling containers 2 designed to contain a pourable product, preferably of the alimentary type (for example, water, beer, wine, fizzy drinks, fruit juices, tea, milk or the like).

In particular, the machine 1 is configured to label the containers 2 using labels 3 obtained from a strip 4 of labeling material.

For the sake of simplicity, reference will be made below to a labeling machine 1 operating with glued labels 3 of the aforementioned type, to which the present description will refer without thereby losing its general character.

However, that which is described and claimed below is likewise applicable in the case of the sleeve labels described above.

Preferably, the containers 2 consist of bottles or flacons made of plastic or glass.

Preferably, the machine 1 forms part of a packaging line of the known type including, for example, at least one filling machine for filling the containers 2 with the pourable product and the labeling machine 1.

The packaging line may also comprise one or more of the following units: blowing machine, rinsing machine, capping machine

The labeling machine 1 comprises a rotating conveyor 5 which is configured to move the containers 2 along a labeling path. The labeling machine 1 comprises a labeling module 6. The module 6 is arranged along the periphery of the rotating conveyor 5. The conveyor may be defined by a carousel 5 which is rotatable about a central axis Z, which is preferably vertical, and is configured to convey a series of containers 2 to be labeled along a labeling path, which is preferably horizontal, in the form of a circle arc.

The labeling module 6 is arranged along the periphery of the carousel 5 and is configured to prepare, transport and feed a plurality of labels 3 to the said carousel 5 at an application station A so that these labels 3 can be applied onto the respective containers 2.

Preferably, the strip 4 is initially wound up in the form of a continuous strip onto a reel 4a.

The strip 4 is formed by a plurality of labels 3 which are initially joined together longitudinally in the form of a continuous strip, which is initially wound up on a reel 4a.

The labeling module 6 comprises a storage unit including at least one support shaft 7 which is mounted rotatably on the module 6 so as to support one said reel 4a at a time.

The module 6 comprises a feeding system 8. The feeding system comprises a feed roller 8a for supplying/feeding the strip 4 along a feed path P. The feed roller 8a has an axis Y and is rotatable about the axis Y so as to define a linear peripheral speed of the feed roller 8a. The feed roller 8a, by means of this linear peripheral speed of the feed roller 8a, is able to feed the strip along the feed path P. The feed roller 8a is motor-driven.

The feeding system 8 also comprises a presser roller 8b. The presser roller 8b is rotatable about an associated axis which is parallel to the axis Y and is arranged adjacent to the feed roller 8a. The presser roller 8b is arranged with pressure against the feed roller 8a, so as to press the strip 4 against the latter and keep it firmly gripped. As is known, the presence of the presser roller 8b improves the tension of the strip 4 and ensures a correct unwinding and advancing movement thereof. Basically, the presser roller 8b is radially arranged opposite the feed roller 8a so as to assist the latter during unwinding of the strip 4 from the reel 4a and the advancing movement of the strip 4 along the feed path P.

The module 6 comprises a transfer drum 11. The transfer drum 11 is arranged downstream of the feed roller 8a, along the feed path P. The transfer drum 11 is configured to receive a series of labels 3, to transport them and to apply them in sequence onto the respective containers 2, while the containers are conveyed by the carousel 5. The drum 11 has an axis X. The drum 11 is rotatable about the axis X so as to define a linear peripheral speed of the drum 11. By means of this linear peripheral speed, the drum 11 may receive the series of labels 3, transport them and apply them in sequence onto respective containers 2. The labels are applied in the application station A. The drum 11 is motor-driven.

The axis X of the drum 11 is parallel to the axis Y of the feed roller 8a. The axis X of the drum 11 is parallel to the axis Z of the conveyor 5.

In detail, the outer side surface of the drum 11 includes a plurality of receiving sectors 10 (three in the specific example illustrated). Each sector 10, by means of rotation of the drum 10, receives and retains one label 3 at a time. For this purpose, the sector 10 comprises a respective pair of so-called pads, in particular a front pad and a rear pad, which grip during use the longitudinal ends of each label 3.

The transfer drum 11 is therefore configured to apply labels 3 onto the containers 2 conveyed by the rotating conveyor 5.

In greater detail, the drum 11 is configured to receive in sequence the labels 3, to retain the labels 3 by means of suction and, after rotation through a given angle around its axis X, to release the labels 3 to the application station A, so that they can be applied onto the respective containers 2. The drum 11 is also configured to space angularly the labels from each other, so as to adapt them to the interval between the containers 2.

The module 6 comprises a cutting device 12. The cutting device 12 comprises a cutting roller 12a for repeatedly cutting the strip 4 at a cutting station C so as to separate in sequence the labels 3 from the strip. The cutting station C is arranged along the feed path P. The cutting roller 12a has an axis and is rotatable about the axis of the cutting roller 12a so as to define a linear peripheral speed of the cutting roller 12a. The cutting roller 12a, by means of a linear peripheral speed of the cutting roller 12a, may repeatedly cut the strip so as to separate in sequence the labels from the strip.

The axis of the cutting roller 12a is parallel to the axis Y of the feed roller 8a and the axis X of the drum 11.

The cutting roller 12a transports and/or defines at least one cutting member, for example a blade or knife, for interacting cyclically with the strip 4 in order to cut it repeatedly.

The cutting device 12 also comprises a counter-blade roller 12b which is arranged adjacent to the cutting roller 12a. The counter-blade roller 12b carries and/or defines a counter-blade element (not shown), for example a recess designed to be cyclically engaged by the cutting member or a bearing surface for the cutting member. The cutting roller 12a is motor-driven.

The feed roller 8a feeds the strip towards the cutting roller 12a and the drum 11.

The module 6 comprises a control unit 13.

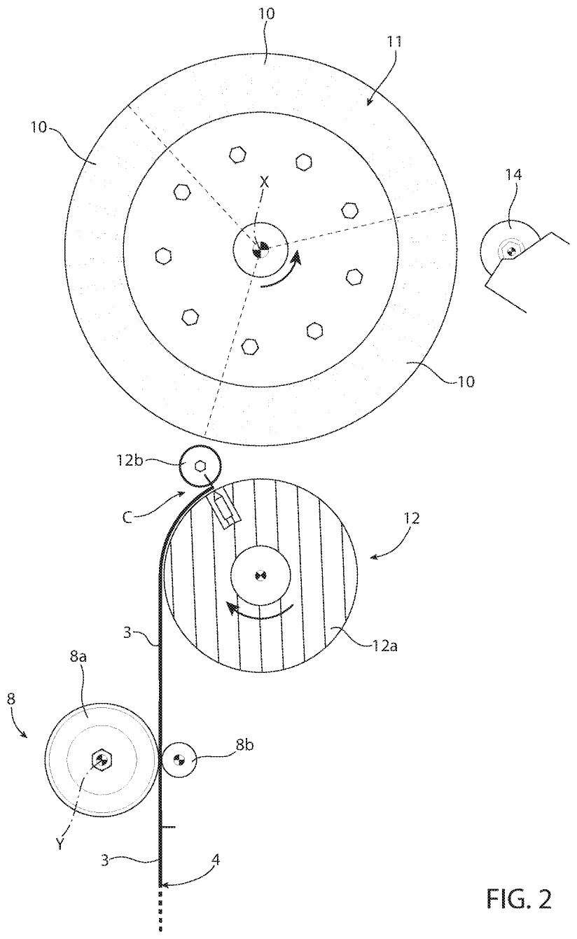

The module 6 is configured to operate in a normal working condition, in which the transfer drum 11, the cutting roller 12a and the feed roller 8a operate at respective linear peripheral working speeds. In the working condition, the containers are labeled by means of respective labels, each of which has a desired length. In FIG. 2 a strip sector with the desired length can be seen between two transverse marks.

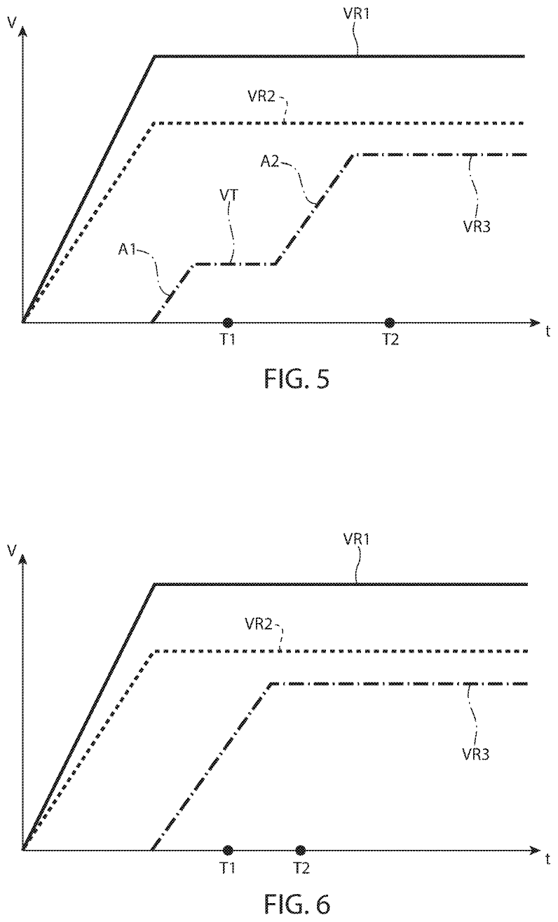

The module 6 is configured to operate during a transient start-up condition, in which the transfer drum 11, the cutting roller 12a and the feed roller 8a are accelerated from respective initial linear peripheral speeds, which are preferably zero, to respective linear peripheral working speeds. In FIGS. 5 and 6, “VR1” is the linear peripheral working speed of the drum 11. In FIGS. 5 and 6, “VR2” is the linear peripheral working speed of the cutting roller 12a. In FIGS. 5 and 6, “VR3” is the linear peripheral working speed of the feed roller 8a. FIGS. 5 and 6 relate to an example of a situation in which the initial linear peripheral speeds are zero. FIGS. 5 and 6 show: in the form of a continuous line an example of the progression over time of the linear peripheral speed of the drum 11; in the form of a broken line an example of the progression over time of the linear peripheral speed of the cutting roller 12a; and in the form of a dot-dash line an example of the progression over time of the linear peripheral speed of the feed roller 8a. In the working condition, the containers 2 are labeled with labels which have the desired length.

The control unit 13 is configured to control, during the transient start-up condition, the start-up of the transfer roller 11, the cutting roller 12a and the feed roller 8a from the respective initial speeds to the respective working speeds.

The control unit 13 is configured to activate automatically the start-up of the feed roller 8a after the transfer drum 11 and the cutting roller 12a have reached the respective peripheral working speeds. FIG. 2 shows the instant in which the feed roller 8a is started.

In this way the quantity of labeling material to be discarded is minimized, owing to the delayed start-up of the feed roller 8a. Therefore a labeling module which is more efficient during start-up is provided.

In the normal working condition, the conveyor 5 is synchronized with the drum 11 so that the labels are correctly applied.

The start-up condition has the function of allowing the labeling module to be synchronized with the conveyor 5.

The cutting device 12 is arranged between the feeding system 8 and the drum 11. The cutting roller 12a is configured to release in sequence the separated labels to the drum 11. Alternatively, the cutting roller 12a could separate the labels, while they are being transported by the drum 11.

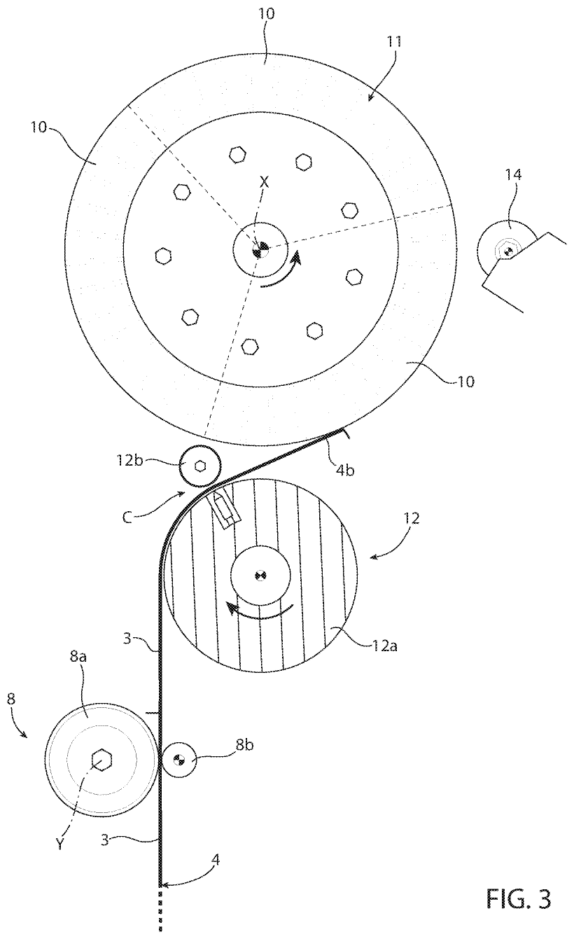

The control unit 13 is configured to control automatically, during said transient start-up condition, the cutting roller 12a and the feed roller 8a so that the cutting roller 12a cuts the strip 4 at least once during start-up of the feed roller 8a from the respective initial speed to the respective working speed VR3. In particular, the control unit 13 is configured to control automatically, during said transient start-up condition, the cutting roller 12a and the feed roller 8a so that the cutting roller 12a performs at least a first cut T1 of the strip 4 during start-up of the feed roller 8a from the respective initial speed to the respective working speed VR3, in order to separate from the strip 4 a first strip portion 4b having a length smaller than said desired length. In FIGS. 5 and 6 the time instant at which the first cut is performed is indicated by T1. T1 could also indicate directly the first cut. FIG. 3 shows the module during the instant in which the first cut is made. The first strip portion is indicated by 4b. It can be noted that the cut in FIG. 3 is performed at a point which does not correspond to the second transverse mark and therefore the first portion 4b has a length smaller than the desired length.

By means of start-up of the feed roller 8a such that the feed roller 8a starts when the cutting roller 12a is already at the respective working speed VR2 and at least one first cut T1 is performed during start-up of the feed roller 8a, it is possible simultaneously to reduce the quantity of labeling material to be discarded and to obtain or allow an overall gentler acceleration of the feed roller 8s during start-up, so as to avoid the need for mechanical systems in order to compensate for the possible excessive stretching of the strip, such as for example buffers and/or disengaging mechanisms. In this way a labeling module which is more efficient during start-up and which has a limited mechanical complexity is provided.

The feed roller 8a is motor-driven.

The first strip portion 4b has a length of between 10% and 50% of the desired length. This length may be between 15% and 30% of the desired length. This length is preferably between 15% and 20% of the desired length. This length is even more preferably equal to 18% of said desired length.

A length which satisfies the aforementioned requirements results in a reduction of the maximum torque and/or force and/or power of the motor of the feed roller 8a during start-up of the feed roller 8a. This condition is guaranteed even more so by adopting in succession the aforementioned requisites regarding the length of the first portion.

Therefore a labeling module which is more efficient during start-up both in terms of material to be discarded and in terms of energy is provided.

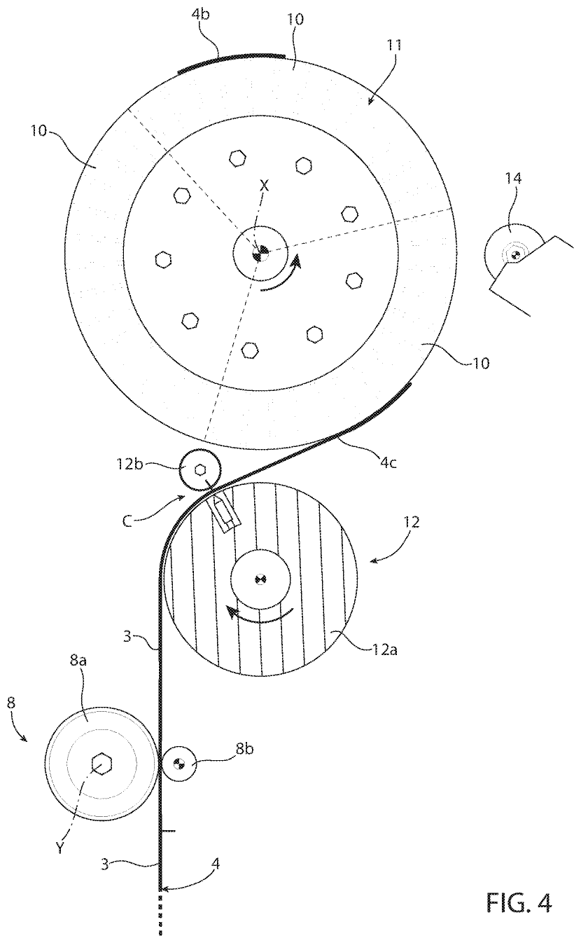

The control unit 13 is configured to control automatically the cutting roller 12a and the feed roller 8a so that the cutting roller 12a performs, after the first cut T1, at least one second cut T2 of the strip 4, so as to separate from the strip 4 a second strip portion 4c which has a length smaller than said desired length. Said second cut T2 is performed at the same time that the feed roller 8a reaches the working speed, in order to optimize the progression of the torque needed for the feed roller 8a to reach the working speed VR3. Said second cut T2 could alternatively be performed after the working speed has been reached by the feed roller 8a. In FIGS. 5 and 6 the time instant at which the second cut is performed is indicated by T2. T2 could also indicate directly the second cut. FIG. 4 shows the module during the instant in which the second cut is made. The second strip portion is indicated by 4c.

The sum of the lengths of the first strip portion 4b and second strip portion 4c is equal to said desired length. In this way the starting position of the strip at the instant of the second cut T2 is correct and therefore, after the second cut T2, the module 6 may operate at working speed in a correct production mode since during start-up a quantity of strip equal to a label has been separated and the feed roller 8a is at the working speed VR3.

Overall, therefore, a module which may be started up suddenly, with a minimum amount of labeling material to be discarded and optimization of the mechanical simplicity of the module, is obtained.

The control unit 13 is configured to control the cutting roller 12a and the feed roller 8a so that the further cut made in the strip 4 by the cutting roller 12a following said second cut T2 causes the separation of a strip portion having said desired length. This further cut results in separation of the first label which will be applied onto a container 2.

The control unit 13 is configured so that start-up of the feed roller 8a comprises at least one zero acceleration section and so that the first cut T1 performed by the cutting roller 12a during start-up of the feed roller 8s occurs during said zero acceleration section. This zero acceleration section is indicated by AT in FIG. 5. By making the first cut T1 during the zero acceleration section the risk of the strip being damaged or torn is reduced. Furthermore, the zero acceleration section further reduces the risk of excessive stressing of the strip 4.

The progression of the peripheral speed of the feed roller 8a during start-up could in any case be of any type. FIG. 6 shows an example in which said progression is a completely linear increase. Said progression could also be at least partly or totally non-linear. FIG. 5 shows an example with two linear sections A1 and A2 between which the aforementioned zero acceleration section AT is temporally arranged.

The module 6 also comprises a gluing device 14 which is arranged along the periphery of the transfer drum 11 and is configured to spread glue over at least part of each label transported by the transfer drum 11.

The gluing device 14 is movable between a gluing position, in which it is substantially tangential to the transfer drum 11 so as to apply in sequence glue to each label 3, and a non-operative position, in which it is spaced from the transfer drum 11.

The control unit 13 is configured to activate automatically the displacement of the gluing device 14 from the non-operative position to the gluing position during start-up of the feed roller 8a from the respective initial speed to the respective working speed VR3.

In this way the time interval during which the start-up of the feed roller 8a occurs may be used to move the gluing device from the non-operative position to the operative position, since the first portion 4b and the second portion 4c prevent the drum 11 from being soiled with glue.

A reduction in the wear of the module and/or a reduction in the cleaning frequency required for at least part of the module is therefore obtained.

As a result it is also possible to allow the use of movement systems (motors, lever systems, transmissions) for moving the gluing device 14 which are less powerful, complex, bulky and costly. The gluing device 14 comprises a gluing roller.

The control unit 13 comprises a first starter for starting the feed roller 8a (preferably a software starter) and a second starter for starting the vacuum drum 11 and the cutting roller 12a (preferably a software starter). According to the invention, the first starter is activated when the cutting roller 12a and drum 11 have reached the respective working speeds. In FIGS. 5 and 6 it can be noted how the speed of the feed roller 8a starts to increase at a time instant following reaching of the respective working speeds by the drum 11 and the cutting roller 12a, indicated by VR1 and VR2.

The Applicant has noted that this configuration allows a significant reduction in the amount of labeling material which is discarded during the transient start-up condition, compared to the case where the accelerations of the feed roller 8a, cutting roller 12a and drum 11 are started simultaneously, as explained in the introductory part of the present description.

In fact, in such a case the feed roller 8a will start to supply the strip 4 along the path P together with the initial acceleration of the drum 11 and the cutting roller resulting in the formation of labels 3 to be discarded for as long as the working condition is not reached, while according to the invention the feed roller 8a will start to supply the strip 4 along the path P only when the cutting roller 12 and the drum 11 are already in the working condition.

Preferably, as schematically shown in the graphs of FIGS. 5 and 6, the working speed VR1 of the drum 11 is greater than the working speed VR2 of the cutting roller 12a, and the cutting speed VR2 of the cutting roller 12a is greater than the working speed VR3 of the feed roller 8a.

This, in order to ensure suitable tensioning of the strip 4 and obtain temporary sliding of the strip 4 on the drum 11, cyclically before each cut, in order to obtain the aforementioned spacing of the labels 3 so that the labels are adapted to the interval between the containers 2.

Alternatively, the working speed of the cutting roller 12a could be the same as the working speed of the drum 11.

The acceleration of the feed roller 8a is controlled so that, during the transient start-up condition, a quantity of labeling material having a length equal to the desired length, namely to a label 3, is in total separated from the strip 4.

This condition is schematically shown in FIGS. 3 and 4, which show two moments during the transient start-up condition. FIG. 3 shows the condition where the first cut T1 has been made in the strip 4 by the cutting roller 12a, so that the first strip portion 4b is separated; FIG. 4 shows the condition where the second cut T2 has been made in the strip 4 by the cutting roller 12a, so that the second strip portion 4c is separated. The graphs in FIGS. 5 and 6 show, along the X axis (time “t”), the cutting instants corresponding to the first cut T1 and the second cut T2. As can be seen, the first cut T1 is performed during start-up of the feed roller 8a, while the second cut T2 is performed once the feed roller 8a has reached its working speed.

By means of the invention, the quantity of the labeling material discarded during the transient start-up condition is limited to a single label 3. Furthermore, by means of the invention, the stresses within the strip 4 are limited compared to the known case, since the acceleration of the feed roller 8a is overall less marked. This minimum amount of discarded labeling material (a single label 3) is “acceptable” in relation to a relatively moderate acceleration of the feed roller 8a, instead of a rapid and sudden acceleration thereof. In fact, such a rapid and sudden acceleration would allow the discarding of material to be avoided, but would result in excessive tensioning of the strip 4, with the risk of stretching or tears. Complicated and costly compensation systems upstream of the feeding system 8, such as buffers or mechanisms for temporarily disengaging the feed roller 8a and the strip 4, are also avoided. Less powerful motors and transmissions may also be used, with a consequent reduction in the overall dimensions and costs.

As a result it is also possible to allow the use of movement systems (motors, lever systems, transmissions) for moving the gluing device 14 which are less powerful, complex, bulky and costly.

An examination of the characteristics of the labeling module and the associated method, provided according to the present invention, clearly reveals the advantages which may be obtained from them.

In particular, owing to the particular method of controlling the initial acceleration of the feed roller 8a in relation to the speed of the cutting roller 12a and the vacuum drum 11 according to the invention and owing to the particular method of controlling the cutting roller 12a and the acceleration of the feed roller 8a during the acceleration of the feed roller 8a from its initial speed to its working speed, it is possible to limit the amount of discarded labeling material during the transient start-up condition of the module 6, in particular to a single label 3, namely a quantity of material with a length equal to the length of a single label 3.

This may be obtained, moreover, while limiting the tensioning stresses on the strip 4 which are caused, during the transient start-up condition, by the acceleration of the feed roller 8a, without the need for complicated and costly systems in order to compensate for and limit the aforementioned stresses.

It will be clear that modifications and variations may be made to the labeling module 6 and to the associated method described here, without thereby departing from the scope of protection defined by the claims.

1. A labeling module for a labeling machine configured to label containers designed to contain a pourable product by means of labels obtained from a strip of labelling material, the module comprising:
a feeding system including a feed roller that feeds the strip along a feed path;
a transfer drum which is arranged downstream of the feed roller, along the feed path, and is configured to receive a series of labels, to transport them and to apply them in sequence onto respective containers; a cutting device including a cutting roller configured to cut repeatedly the strip at a cutting station which is arranged along the feed path, so as to separate in sequence the labels from the strip, the feed roller being configured to supply the strip towards the cutting station; and
a control unit; the module being configured to operate in a normal working condition, in which the transfer drum, the cutting roller and the feed roller operate at respective linear peripheral working speeds, so as to label the containers with labels of a desired length, and in a transient start-up condition, in which the transfer drum, the cutting roller and the feed roller are accelerated from respective initial linear peripheral speeds, which are preferably zero, to respective linear peripheral working speeds; wherein the control unit is configured to control, during the transient start-up condition, the start-up of the transfer drum, the cutting roller and the feed roller from the respective initial speeds to the respective working speeds; wherein the control unit is configured to activate automatically the start-up of the feed roller after the transfer drum and the cutting roller have reached the respective peripheral working speeds.

2. The labeling module as claimed in claim 1, wherein the cutting device is arranged between the feeding system and the drum, and the cutting roller is configured to release the separated labels in sequence to the drum.

3. The labeling module as claimed in claim 1, wherein the control unit is configured to control automatically, during said transient start-up condition, the cutting roller and the feed roller so that the cutting roller cuts the strip at least once during start-up of the feed roller from the respective initial speed to the respective working speed, making a first cut of the strip in order to separate from the strip a first strip portion having a length smaller than said desired length.

4. The labeling module as claimed in claim 3, wherein said strip portion has a length of between 10% and 50% of said desired length, preferably between 15% and 30% of said desired length, more preferably between 15% and 20% of the desired length, and even more preferably equal to 18% of said desired length.

5. The labeling module as claimed in claim 3, wherein the control unit is configured so that the start-up of the feed roller comprises at least one zero acceleration section, so that the first cut made by the cutting roller during start-up of the feed roller takes place during said zero acceleration section.

6. The labeling module as claimed in claim 3, wherein the control unit is configured to control automatically the cutting roller and the feed roller so that the cutting roller performs, after reaching the working speed has been reached or at the same time that the working speed is reached by the feed roller, and after the first cut, a second cut of the strip, in order to separate from the strip a second strip portion having a length smaller than said desired length, a sum of the lengths of said first strip portion and second strip portion being equal to said desired length.

7. The labeling module as claimed in claim 6, wherein the control unit is configured to control automatically the cutting roller and the feed roller so that the further cut made in the strip by the cutting roller following said second cut causes the separation of a strip portion having said desired length.

8. The labeling module as claimed in claim 1, and further comprising a gluing device arranged along the periphery of the transfer drum and configured to spread glue over at least part of each label transported by the transfer drum, the gluing device being movable between a gluing position, in which it is substantially tangential to the transfer drum so as to apply in sequence glue to each label, and a non-operative position, in which it is spaced from the transfer drum; and wherein the control unit is configured to activate automatically a displacement of the gluing device from the non-operative position to the gluing position during start-up of the feed roller from the respective initial speed to the respective working speed.

9. A packaging line for packaging a pourable product inside containers (2), the packaging line comprising:
a filling machine for filling the containers with the pourable product; and
a labeling machine for labeling the containers; wherein the labeling machine comprises a rotating conveyor for moving the containers along a labeling path and a labeling module as claimed in any one of the preceding claims, the module being arranged along the periphery of the rotating conveyor, the transfer drum being configured to apply labels onto the containers conveyed by the rotating conveyor; and wherein, in said normal working condition, the conveyor is synchronized with the drum so that the labels are correctly applied.

10. A method for labeling containers designed to contain a pourable product, the method comprising the steps of:
feeding a strip with a motor-driven feed roller along a feed path;
repeatedly cutting the strip with a cutting device including a motor-driven cutting roller, at a cutting station which is arranged along the feed path, so as to separate in sequence the labels from the strip, the feed roller being configured to supply the strip towards the cutting station;
receiving a series of labels by a motor-driven transfer drum arranged downstream of the feed roller, along the feed path, transporting the labels and applying the labels in sequence onto respective containers;
operating in a normal working condition, in which the transfer drum, the cutting roller and the feed roller operate at respective linear peripheral working speeds, so as to label the containers with labels having a desired length;
operating in a transient start-up condition, in which the transfer drum, the cutting roller and the feed roller are accelerated from respective initial linear peripheral speeds, which are preferably zero, to the respective linear peripheral working speeds;
controlling, during the transient start-up condition, the start-up of the transfer drum, the cutting roller and the feed roller from the respective initial speeds to the respective working speeds; and
automatically activating the start-up of the feed roller after the transfer drum and the cutting roller have reached the respective working speeds.

11. The method as claimed in claim 10, comprising, by means of the cutting roller, releasing the separated labels in sequence to the drum.

12. The method as claimed in claim 10, comprising automatically controlling, during said transient start-up condition, the cutting roller and the feed roller so that the cutting roller cuts the strip at least once during start-up of the feed roller from the respective initial speed to the respective working speed, making a first cut of the strip in order to separate from the strip a first strip portion having a length smaller than said desired length.

13. The method as claimed in claim 12, wherein said strip portion has a length of between 10% and 50% of said desired length, preferably between 15% and 30% of said desired length, more preferably between 15% and 20% of the desired length, and even more preferably equal to 18% of said desired length.

14. The method as claimed in claim 12, wherein the start-up of the feed roller comprises at least one zero acceleration section, so that the first cut made by the cutting roller during start-up of the feed roller takes place during said zero acceleration section.

15. The method as claimed in claim 12, comprising automatically controlling the cutting roller and the feed roller so that the cutting roller performs, after the working speed has been reached or at the same time that the working speed is reached by the feed roller and, after the first cut, a second cut of the strip, in order to separate from the strip a second strip portion having a length smaller than said desired length, a sum of the lengths of said first strip portion and second strip portion being equal to said desired length.

16. The method as claimed in claim 15, comprising automatically controlling the cutting roller and the feed roller so that the further cut made in the strip by the cutting roller following said second cut causes the separation of a strip portion having said desired length.

17. The method as claimed in claim 10, further comprising:
spreading glue over at least part of each label transported by the transfer drum using a gluing device arranged along the periphery of the transfer drum, spreading glue over at least part of each label transported by the transfer drum, the gluing device being movable between a gluing position, in which the gluing device is substantially tangential to the transfer drum for applying in sequence the glue onto at least part of each label transported by the drum, and a non-operative position, in which it is spaced from the transfer drum; and
automatically activating a displacement of the gluing device from the non-operative position to the gluing position during start-up of the feed roller from the respective initial speed to the respective working speed.

18. The method as claimed in claim 10, further comprising packaging a pourable product in containers, comprising:
filling the containers with the pourable product; and
labeling the containers while the containers are conveyed using a conveyor; wherein, in said normal working condition, the conveyor is synchronized with the drum so that the labels are correctly applied.
